(19) United States
(12) Patent Application Publication
(10) Pub. No.: US 2023/0176851 A1
(43) Pub. Date: Jun. 8, 2023

(54) COMPUTER-READABLE RECORDING MEDIUM STORING CONVERSION PROGRAM AND CONVERSION METHOD

(71) Applicant: Fujitsu Limited, Kawasaki-shi (JP)

(72) Inventor: Keisuke TSUGANE, Kawasaki (JP)

(73) Assignee: Fujitsu Limited, Kawasaki-shi (JP)

(21) Appl. No.: 17/902,446

(22) Filed: Sep. 2, 2022

(30) Foreign Application Priority Data
Dec. 7, 2021 (JP) 2021-198907

(51) Int. Cl. G06F 8/65; G06F 8/41

(52) U.S. Cl. CPC G06F 8/65; G06F 8/452

(57) ABSTRACT

A recording medium stores a program causing a computer to execute a process including: generating, based on a dependency relationship between statements in a program, a directed graph in which the statement in the program is a node and the dependency relationship is an edge; detecting, based on the dependency relationship represented by the edge, a node of which a part of a loop process has a dependency relationship with another preceding or following node, from the directed graph; updating the directed graph by dividing the detected node into a first node having the part of the loop process and a second node having a loop process other than the part of the loop process, fusing the divided first node and the another node, and assigning dependency information based on a data access pattern to a node after fusing; and converting the program, based on the directed graph after update.

### CROSS-REFERENCE TO RELATED APPLICATION

This application is based upon and claims the benefit of priority of the prior Japanese Patent Application No. 2021-198907, filed on Dec. 7, 2021, the entire contents of which are incorporated herein by reference.

### FIELD

The embodiments discussed herein are related to a non-transitory computer-readable recording medium storing a conversion program and a conversion method.

### BACKGROUND

In the field of high performance computing (HPC), parallel programming for shared-memory type processors is a mainly data parallel description by open multi-processing (OpenMP). In the data parallel, a parallelizable loop is divided and allocated to each thread to be executed in parallel. In order to ensure computation completion after the loop is executed, overall synchronization is performed between the threads used for parallel execution.

International Publication Pamphlet No. WO 2007/096935 and Japanese Laid-open Patent Publication No. 2009-104422 are disclosed as related art.

### SUMMARY

According to an aspect of the embodiments, a non-transitory computer-readable recording medium stores a conversion program causing a computer to execute a process including: generating, based on a dependency relationship between statements in a program, a directed graph in which the statement in the program is a node and the dependency relationship is an edge; detecting, based on the dependency relationship represented by the edge in the generated directed graph, a node of which a part of a loop process has a dependency relationship with another preceding or following node, from the directed graph; updating the directed graph by dividing the detected node into a first node that has the part of the loop process and a second node that has a loop process other than the part of the loop process, fusing the divided first node and the another node, and assigning dependency information based on a data access pattern to a node after fusing; and converting the program, based on the directed graph after update.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1A is an explanatory diagram illustrating an example of a conversion method according to Embodiment 1;

FIG. 1B is an explanatory diagram illustrating an example of overall synchronization between threads;

FIG. 1C is an explanatory diagram illustrating an example of a program of a dependent task parallel description;

FIG. 2 is a block diagram illustrating a hardware configuration example of an information processing apparatus according to Embodiment 2;

FIG. 3 is an explanatory diagram illustrating a specific example of a program to be converted;

FIG. 4 is a block diagram illustrating a functional configuration example of the information processing apparatus according to Embodiment 2;

FIG. 5A is an explanatory diagram illustrating a specific example of a directed graph;

FIG. 5B is an explanatory diagram illustrating a specific example of data access information;

FIG. 6 is a first explanatory diagram (part 1) illustrating an example of updating the directed graph;

FIG. 7 is an explanatory diagram (part 2) illustrating the example of updating the directed graph;

FIG. 8 is a third explanatory diagram (part 3) illustrating the example of updating the directed graph;

FIG. 9 is an explanatory diagram (part 4) illustrating the example of updating the directed graph;

FIG. 10 is an explanatory diagram illustrating a division example of a preceding node;

FIG. 11 is an explanatory diagram illustrating a determination example of a task granularity of a following node;

FIG. 12 is an explanatory diagram illustrating a specific example of a program after conversion;

FIG. 13 is a flowchart illustrating an example of a conversion process procedure of the information processing apparatus according to Embodiment 2; and

FIG. 14 is a flowchart illustrating an example of a specific processing procedure of a division and fusion process.

### DESCRIPTION OF EMBODIMENTS

For example, there is a technique of obtaining a reversibly degenerate dependent element group by using program analysis information including a plurality of dependent elements representing a dependency relationship between a statement and control of a program, and generating a program dependency graph in which the dependent element is degenerated by degenerating the dependent element group. There is another technique in which, in response to a generation policy of a parallel code input by a user, a process of the code is divided, and a parallelization method is obtained while predicting an execution cycle from a computation amount, process contents, cache use of reused data, and a main memory access data amount.

Meanwhile, in the related art, program parallelization efficiency is decreased, in some cases. For example, when a cost of the overall synchronization is increased due to an increase in the number of cores of the shared-memory type processor or a variation in computation, the parallelization efficiency is decreased and program performance is decreased.

In one aspect, an object of the present disclosure is to improve parallelization efficiency of a program.

Hereinafter, embodiments of a conversion program and a conversion method according to the disclosure are described in detail with reference to the drawings.

### Embodiment 1

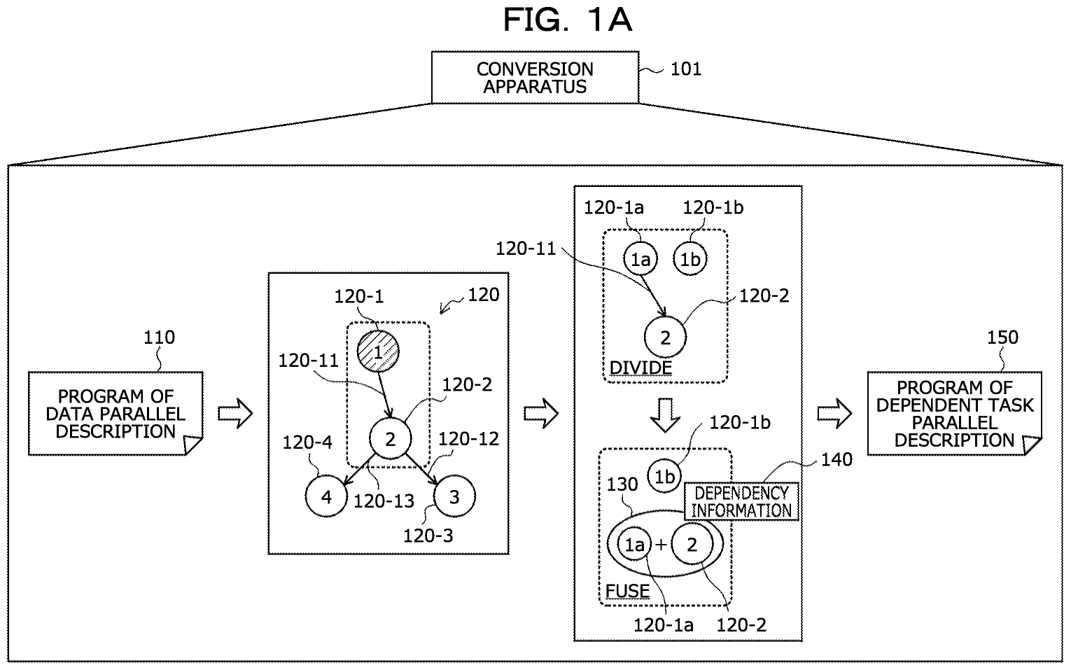

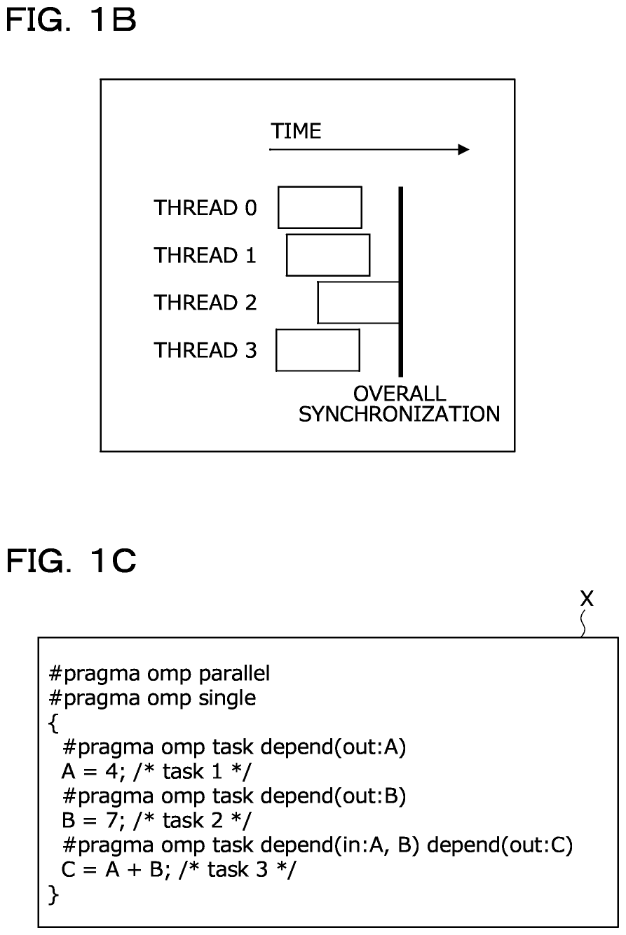

FIG. 1A is an explanatory diagram illustrating an example of a conversion method according to Embodiment 1. As illustrated in FIGS. 1A to 1C, a conversion apparatus 101 is a computer that converts a program of a data parallel description into a program of a dependent task parallel description. For example, a personal computer (PC) is used as the conversion apparatus 101. The conversion apparatus 101 may be a server.

The data parallel description is a description for performing a computation by data parallel. In the field of HPC, parallel programming for a shared-memory type processor often uses a data parallel description by OpenMP. The OpenMP is an application programming interface (API) that enables parallel programming in a shared-memory type machine.

In the OpenMP, a description is made by using an instruction statement to a compiler called a pragma directive (#pragma). For example, by designating the instruction statement for a parallelizable loop, the loop may be divided and allocated to each thread to be executed in parallel. In order to ensure computation completion after the loop is executed, overall synchronization is performed between the threads used for parallel execution. Meanwhile, in a case where there is no dependency relationship between a plurality of loops, it is also possible that the threads are not synchronized with each other.

On the other hand, the number of cores of the shared-memory type processor is increasing year by year, and a cost of the overall synchronization tends to be increased. The overall synchronization between the threads will be described with reference to FIG. 1B.

FIG. 1B is an explanatory diagram illustrating an example of overall synchronization between threads. In FIG. 1B, each of threads 0 to 3 is a thread allocated to each core. Here, it is assumed that a parallelizable loop is divided and allocated to each of the threads 0 to 3 to be parallelized.

In this case, overall synchronization is performed between the threads to ensure computation completion after the execution of the loop. In the example in FIG. 1B, the other thread 0, 1, and 3 may not start other computations until a computation of the thread 2 (core) ends, due to the overall synchronization.

Therefore, in order to increase a speed of a program, for example, it is desirable to reduce the overall synchronization as much as possible, and start the computations one after another by the empty thread (core) with more fine-grained synchronization. Meanwhile, since a user is requested to determine whether or not there is a dependency relationship between the loops and to perform programming that causes the dependency relationship to disappear, there is a problem that an implementation cost is increased.

The dependent task parallel description is a description for speeding up a program from overall synchronization to inter-task synchronization, by making a computation a task and explicitly describing read/write of data to be used in the task. The tasks are executed in parallel based on data-dependent descriptions (in, out, and inout) between the tasks in dependent task parallel by OpenMP.

FIG. 1C is an explanatory diagram illustrating an example of a program of a dependent task parallel description. A program X in FIG. 1C is an example of a program implemented by the dependent task parallel description. Since there is no dependency relationship between a task 1 and a task 2 in the program X, the programs are executed in parallel. On the other hand, since a task 3 has a flow dependency with the tasks 1 and 2 (Read After Write for variables A and B), the task 3 is executed after inter-task synchronization instead of overall synchronization.

In data parallel, the data is divided and mapped to the threads. By contrast, in task parallel, a task is generated, and it is determined by a runtime of a compiler whether a dependency is released from the task that is completely executed, and the task is executed, so that the procedure is complicated and many. Therefore, an overhead of the task parallel is larger as compared with an overhead of the data parallel.

As described above, in the data parallel description, a cost of the overall synchronization is high. It is difficult for the user to grasp the dependency relationship of the entire program and perform programming to reduce the overall synchronization. The task parallel has the larger overhead as compared with the data parallel.

Accordingly, in Embodiment 1, a conversion method will be described in which the program implemented by the data parallel description is automatically converted to the dependent task parallel description so as to reduce the number of task generations and increase parallelization efficiency while setting the tasks with an appropriate granularity and obtaining parallelism. Hereinafter, process examples ((1) to (4) below) of the conversion apparatus 101 will be described.

(1) Based on a dependency relationship between statements in a program, the conversion apparatus 101 generates a directed graph in which the statement in the program serves as a node and the dependency relationship between the statements serves as an edge. The program is a program to be converted, for example, a program of a data parallel description.

The statement is each statement such as a procedure, a command, or a declaration, which is a configuration unit of the program, and includes, for example, an equation, a function call, and the like. For example, the equation is a combination of a value, a variable, an operator, a function, and the like. The dependency relationship between the statements is, for example, a relationship based on a data dependency such as a flow dependency, an inverse flow dependency, and an output dependency.

The flow dependency is that written data is read out after the writing (Read After Write). The inverse flow dependency is opposite to the flow dependency, and writing is performed after reading (Write After Read). The output dependency is a dependency in which a separate value is written after writing (Write After Write). Even when there is a dependency relationship based on any data dependency of the flow dependency, the inverse flow dependency, and the output dependency between the statements, the statements may not be executed in parallel.

The directed graph is a graph including nodes and edges coupling the nodes, and each edge has a direction. A node that is not coupled to a separate node by the edge may be included in the directed graph. The node has, for example, data access information of the statement. For example, the data access information indicates an access range or an access pattern of the loop process. For example, the access pattern is represented by a variable or the like of an access (read/write) destination.

For example, the conversion apparatus 101 analyzes a dependency relationship between the statements in a program 110 by dependency analysis of the program 110 with a compiler. The program 110 is a program of a data parallel description. Based on a result of the dependency analysis of the program 110, the conversion apparatus 101 generates a directed graph 120.

The directed graph 120 includes nodes (for example, nodes 120-1 to 120-4) representing statements in the program 110 and edges (for example, edges 120-11 to 120-13) representing a dependency relationship between the statements. The dependency relationship is a relationship based on data dependency (flow dependency, inverse flow dependency, and output dependency).

(2) Based on the dependency relationship represented by the edge in the generated directed graph, the conversion apparatus 101 detects, from the directed graph, a node of which a part of a loop process has a dependency relationship with another preceding or following node. For example, it is assumed that a statement 1 represented by the node 120-1 has a loop process of reading and writing data from and to A[i] in a range from “i=0” to “i=N−1”.

It is assumed that a statement 2 represented by the node 120-2 has only a read for A[0]. In this case, the statements 1 and 2 depend only on A[0]. The statement 1 and statement 2 do not depend on each other in a range from “i=1” to “i=N−1”.

A case is assumed in which the node 120-1 is detected from the directed graph 120. The node 120-1 is a node of which a part of the loop process (i=0) has a dependency relationship with the other preceding node 120-2.

(3) The conversion apparatus 101 divides the detected node into a first node having a part of the loop process and a second node having the loop process other than the part of the loop process, and fuses the divided first node and the other node. The part of the loop process is a loop process having a dependency relationship with another preceding or following node, in the loop process of the detected node. The fusing of the nodes means that two nodes are collectively handled as one task.

By assigning dependency information based on data access pattern to the node after fusing, the conversion apparatus 101 updates the directed graph. The dependency information is information indicating what kind of access (read, write) is made to which data in a process (task) of each node. For example, the dependency information includes information such as “depend (out: A[0])” assigned after #pragma omp. With the dependency information, it is possible to determine what kind of dependency exists between the task and a separate task.

For example, the conversion apparatus 101 divides the node 120-1 into a first node 120-1a and a second node 120-1b. The first node 120-1a is a node having a part of the loop process having a dependency relationship with the other preceding node 120-2, in the loop process of the node 120-1. The second node 120-1b is a node having a loop process other than the part of the loop process having the dependency relationship with the other preceding node 120-2, in the loop process of the node 120-1.

After that, the conversion apparatus 101 fuses the divided first node 120-1a and the other node 120-2. A node 130 after fusing is obtained by fusing the first node 120-1a and the other node 120-2 as one task. The conversion apparatus 101 updates the directed graph 120 by assigning the dependency information based on the data access pattern to the node 130 after fusing.

In details, for example, the conversion apparatus 101 assigns dependency information 140 to the node 130 after fusing. The dependency information 140 indicates what kind of access (read, write) is made to which data when the node 130 after fusing is executed as one task.

(4) The conversion apparatus 101 converts the program based on the directed graph after update. For example, the conversion apparatus 101 converts the program 110 of the data parallel description into a program 150 of the dependent task parallel description, based on the directed graph 120 after update.

As an existing function of the compiler, there is a function of performing reversible conversion that restores an original program based on information obtained by creating a directed graph of the program. The conversion of the dependent task parallel description into the program 150 based on the directed graph 120 after update may be performed by using the existing function of such a compiler, for example.

As described above, with the conversion apparatus 101 according to Embodiment 1, in a case where only a part of the loop process of the node in the directed graph has a dependency relationship with the other preceding or following node, it is possible to divide only the part into a separate node and fuse the separate node and the other node. Therefore, in task parallelization, it is possible to reduce the number of generated tasks while acquiring parallelism, and to improve parallelization efficiency. For example, the conversion apparatus 101 may improve performance of the program by finding out parallelism, by performing division and fusion of the nodes based on a loop length or the data access pattern of the task target process.

### Embodiment 2

Next, a conversion method according to Embodiment 2 will be described. A case where the conversion apparatus 101 illustrated in FIGS. 1A to 1C is applied to an information processing apparatus 200 will be described as an example. A description of the same location as the location described in Embodiment 1 is omitted herein.

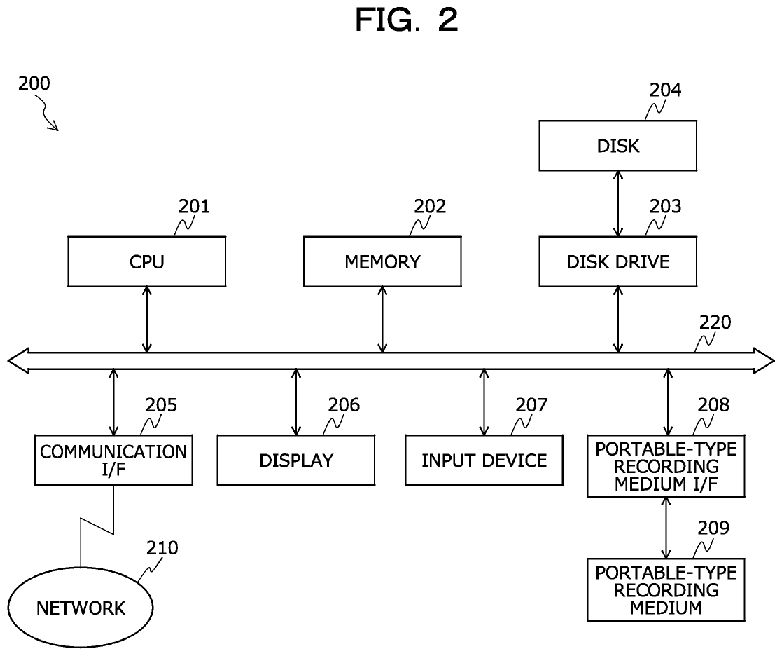

First, an example of a hardware configuration of the information processing apparatus 200 according to Embodiment 2 is described with reference to FIG. 2. The information processing apparatus 200 is, for example, a PC, a tablet PC, or the like used by a user. Meanwhile, the information processing apparatus 200 may be a server accessible from the PC or the like used by the user.

FIG. 2 is a block diagram illustrating a hardware configuration example of the information processing apparatus 200 according to Embodiment 2. In FIG. 2, the information processing apparatus 200 includes a central processing unit (CPU) 201, a memory 202, a disk drive 203, a disk 204, a communication interface (I/F) 205, a display 206, an input device 207, a portable recording medium I/F 208, and a portable-type recording medium 209. The respective components are coupled to each other through a bus 220.

The CPU 201 controls an entirety of the information processing apparatus 200. The CPU 201 may include a plurality of cores. The memory 202 includes, for example, a read-only memory (ROM), a random-access memory (RAM), a flash ROM, and the like. For example, the flash ROM stores a program of an operating system (OS), the ROM stores an application program, and the RAM is used as a work area of the CPU 201. The programs stored in the memory 202 cause the CPU 201 to execute a coded process by being loaded into the CPU 201.

The disk drive 203 controls reading and writing of data from and to the disk 204 according to the control of the CPU 201. The disk 204 stores written data under the control of the disk drive 203. As the disk 204, for example, there are a magnetic disk, an optical disc, and the like.

The communication I/F 205 is coupled to a network 210 via a communication line and coupled to an external computer via the network 210. The communication I/F 205 functions as an interface between the network 210 and an inside of the apparatus and controls an input and an output of data from and to the external computer. For example, a modem, a LAN adapter, or the like may be adopted as the communication I/F 205.

The display 206 is a display device that displays data such as a cursor, icons, and a toolbox, and also displays documents, images, functional information, and the like. As the display 206, for example, a liquid crystal display, an organic electroluminescence (EL) display, or the like may be employed.

The input device 207 has keys for inputting characters, numbers, various instructions, and the like and is used for inputting data. The input device 207 may be a touch panel input pad, a numeric keypad, or the like or may be a keyboard, a mouse, or the like.

The portable-type recording medium I/F 208 controls reading and writing of data from and to the portable-type recording medium 209 in accordance with the control of the CPU 201. The portable-type recording medium 209 stores data written under the control of the portable-type recording medium I/F 208. Examples of the portable-type recording medium 209 include a compact disc (CD)-ROM, a Digital Versatile Disk (DVD), a Universal Serial Bus (USB) memory, and the like.

The information processing apparatus 200 may not include, for example, the disk drive 203, the disk 204, the portable-type recording medium I/F 208, and the portable-type recording medium 209, among the components described above. The conversion apparatus 101 illustrated in FIGS. 1A to 1C may be realized by the same hardware configuration as the hardware configuration of the information processing apparatus 200.

(Specific Example of Program to be Converted)

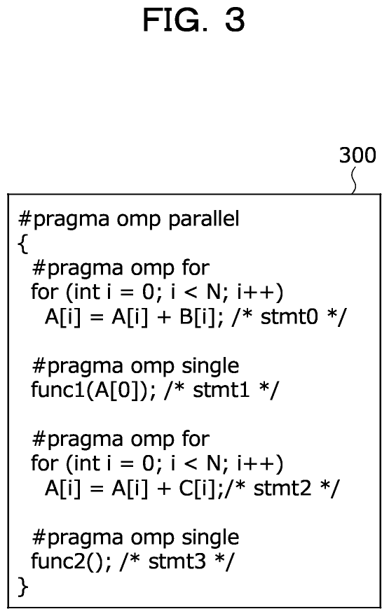

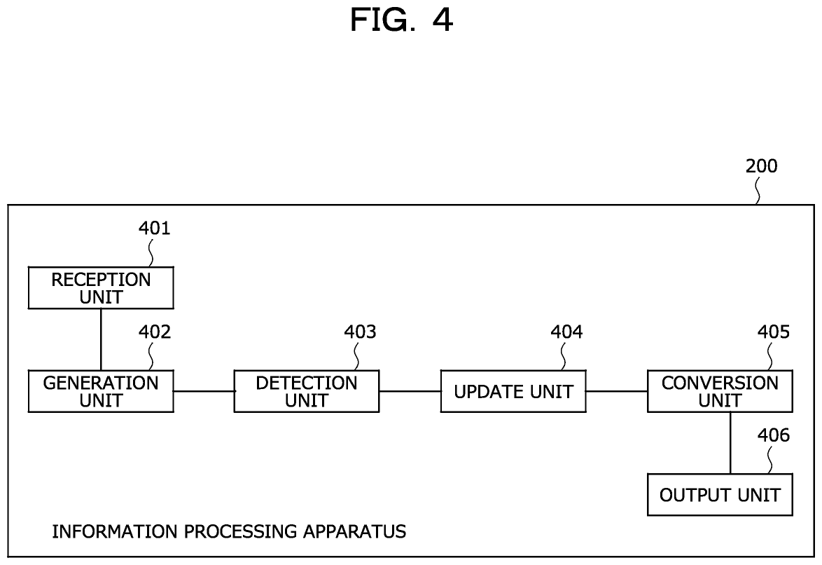

A specific example of a program to be converted will be described with reference to FIG. 3.

FIG. 3 is an explanatory diagram illustrating the specific example of the program to be converted. As illustrated in FIG. 3, a program 300 is a program implemented by a data parallel description by OpenMP. An instruction statement of the OpenMP is inserted into a location at which parallelization is to be performed in the program 300, and designates a parallelization scheme.

The instruction statement of the OpenMP is described by pragma (#pragma), and has a form such as “#pragma omp”. For example, “#pragma omp parallel” designates a section (parallel region) to be executed in parallel. “#pragma omp for” parallelizes a for statement. “#pragma omp single” designates a block to be executed by only one thread.

stmt0, stmt1, stmt2, and stmt3 are identifiers for identifying statements. stmt0 corresponds to “A[i]=A[i]+B[i]”. stmt1 corresponds to “func1(A[0])”. stmt2 corresponds to “A[i]=A[i]+C[i]”. stmt3 corresponds to “func2( )”.

(Functional Configuration Example of Information Processing Apparatus 200)

Next, a functional configuration example of the information processing apparatus 200 according to Embodiment 2 will be described.

FIG. 4 is a block diagram illustrating the functional configuration example of the information processing apparatus 200 according to Embodiment 2. In FIG. 4, the information processing apparatus 200 includes a reception unit 401, a generation unit 402, a detection unit 403, an update unit 404, a conversion unit 405, and an output unit 406. The reception unit 401 to the output unit 406 are functions constituting a control unit. For example, the functions are implemented by causing the CPU 201 to execute a program stored in a storage device such as the memory 202, the disk 204, or the portable-type recording medium 209 illustrated in FIG. 2 or by using the communication I/F 205. A processing result of each functional unit is stored in the storage device such as, for example, the memory 202 or the disk 204.

The reception unit 401 receives a program to be converted. The program to be converted is a program of a data parallel description, for example, a program for HPC. Hereinafter, the program to be converted is referred to as a “program P”, in some cases. For example, the program P is the program 300 as illustrated in FIG. 3.

For example, the reception unit 401 receives the program 300 by an operation input of the user who uses the input device 207 illustrated in FIG. 2. The reception unit 401 may receive the program 300 by receiving the program 300 from an external computer via the communication I/F 205.

Based on a dependency relationship between statements in the program P, the generation unit 402 generates a directed graph G in which the statement in the program P is a node and the dependency relationship between the statements is an edge. The statement is a configuration unit of the program, and includes, for example, an equation, a function call, and the like. The dependency relationship between the statements is, for example, a relationship based on a data dependency of any of a flow dependency, an inverse flow dependency, and an output dependency. The node has, for example, data access information of the statement.

Hereinafter, the directed graph in which the statement in the program P is the node and the dependency relationship between the statements is the edge is referred to as a “directed graph G”, in some cases.

For example, the generation unit 402 analyzes the dependency relationship between the statements in the program P by dependency analysis of the program P by a compiler. The compiler is a translation program that converts a program described in a high-level language into a machine language that may be directly interpreted and executed by a computer. The dependency relationship is represented by, for example, which range of which variable between the statements has a dependency. Based on a result of the dependency analysis of the program P, the generation unit 402 generates the directed graph G.

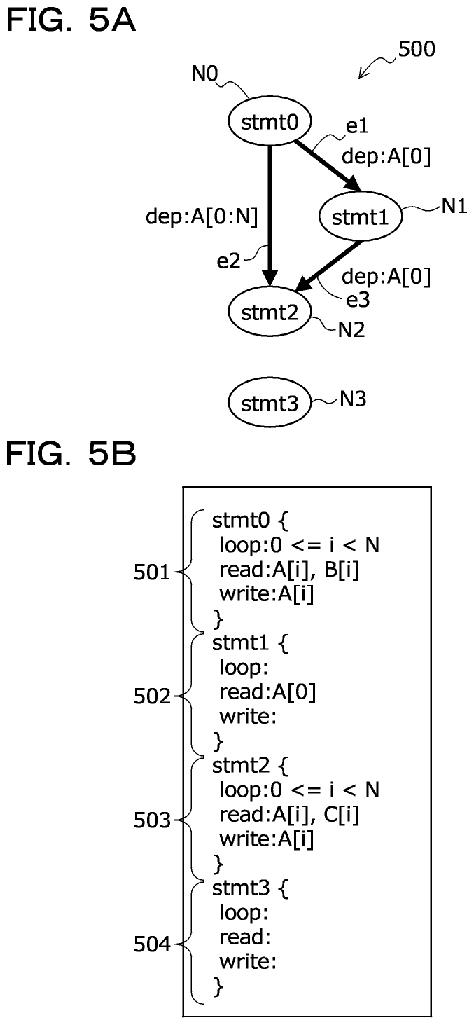

A specific example of the directed graph G will be described below with reference to FIGS. 5A and 5B. Hereinafter, among a plurality of nodes in the directed graph G, arbitrary node is referred to as a “node Ni”, and another node different from the node Ni is referred to as an “other node Nj (j≠i)”, in some cases.

Based on a dependency relationship represented by an edge in the generated directed graph G, the detection unit 403 detects, from the directed graph G, the node Ni of which a part of a loop process has a dependency relationship with the another preceding or following node Nj. The loop process is a process that is repeatedly executed.

The node Ni as the detection target is a node having at least the loop process. The another node Nj preceding the node Ni is the node Nj on a root side of the edge, which is coupled to the node Ni by the edge. The another node Nj following the node Ni is a node on a front side of an edge, which is coupled to the node Ni by the edge.

For example, the detection unit 403 determines whether or not a part of the loop process of the node Ni has a dependency relationship with the another node Nj, based on a dependency relationship between the nodes Ni and Nj, which represent which range of which variable is dependent. In a case where the part of the loop process has the dependency relationship with the another node Nj, the detection unit 403 detects the node Ni.

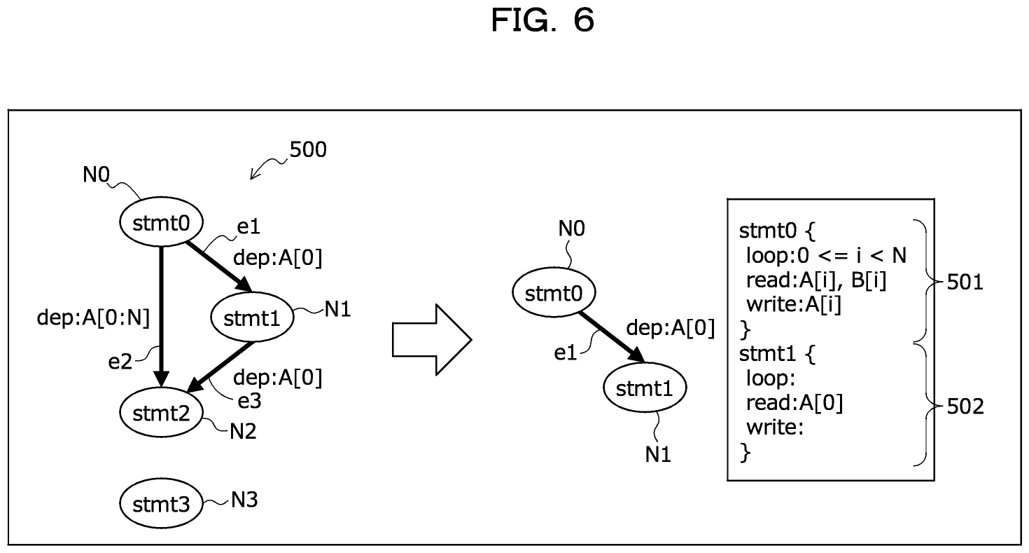

An example of detecting a node from the directed graph G will be described below with reference to FIG. 6.

The update unit 404 divides the detected node Ni into a first node and a second node, fuses the divided first node and the another node Nj, and assigns dependency information based on a data access pattern to the node after fusing to update the directed graph G.

The first node is a node having only a part of the loop process having a dependency relationship with the another node Nj, in the loop process of the node Ni. The second node is a node having only the loop process other than the part of the loop process having the dependency relationship with the another node Nj, in the loop process of the node Ni. The fusing of the nodes means that two nodes are collectively handled as one task, and corresponds to a setting of a granularity of the task.

In a case where there is a dependency relationship between the node after fusing and the other node, the node after fusing and the other node are coupled by an edge. In a case where there is a dependency relationship between the second node and the other node, the second node and the other node are coupled by an edge.

The dependency information based on the data access pattern is information indicating what kind of access (read or write) is made to which data in the process (task) of each node. The dependency information assigned to the node after fusing is specified from, for example, data access information of the node after fusing.

For example, the dependency information includes information such as “depend (out: A[0])” assigned after #pragma omp. out: A[0] indicates writing to A[0]. The dependency information is information for making it possible to determine what kind of dependency exists between a task and a separate task at a runtime of the compiler.

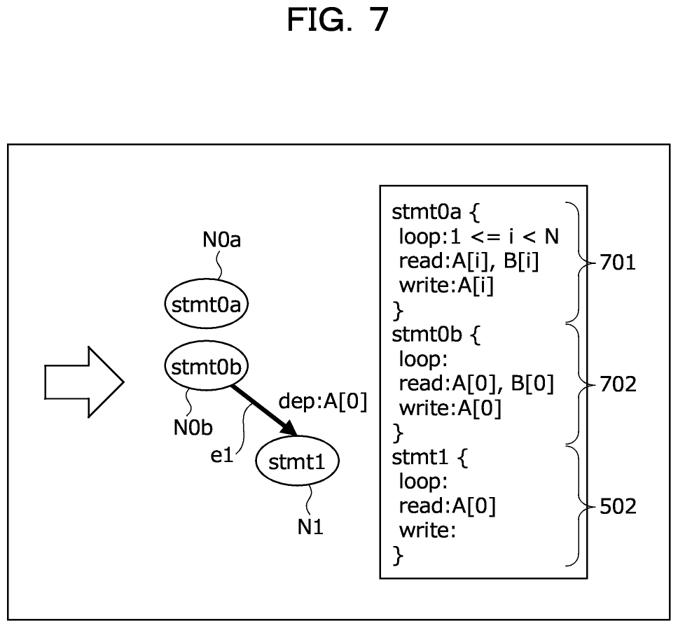

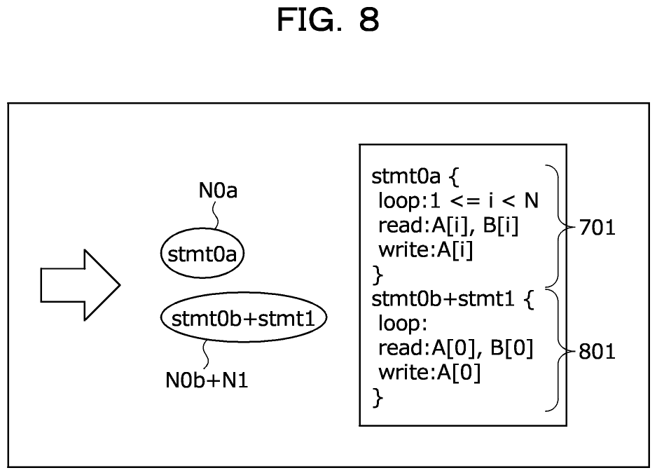

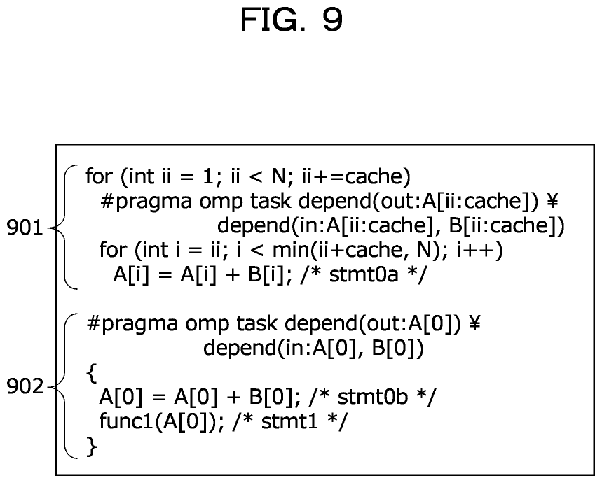

An example of dividing the node Ni will be described below with reference to FIG. 7. A fusion example of the first node divided from the node Ni and the another node Nj will be described below with reference to FIGS. 8 and 9.

The update unit 404 determines whether or not a node preceding the divided second node has a loop process. At this time, in a case where there are a plurality of nodes preceding the second node, the update unit 404 determines whether or not any node preceding the second node has the loop process.

In a case where the node preceding the second node does not have the loop process, the update unit 404 determines a task granularity (division granularity) in a case where the loop process of the second node is divided into a plurality of tasks, based on hardware information. The hardware information is information on hardware that executes the program P after conversion, and includes, for example, a size of a cache line of a core to which a task is allocated. The task granularity is represented by, for example, a loop length.

For example, the update unit 404 determines the task granularity such that the loop length is fitted in the size of the cache line. For the second node, the update unit 404 sets the determined task granularity, and assigns dependency information based on the data access pattern to update the directed graph G. For example, the dependency information assigned to the second node is specified from the data access information and the task granularity of the second node.

Therefore, the update unit 404 divides the loop process of the second node and enables the plurality of tasks to execute the loop process in parallel. At this time, in order to reduce the number of generated tasks, the update unit 404 sets a task granularity (division granularity) in consideration of the size of the cache line corresponding to the amount of data that may be processed at one time. Meanwhile, in a case where the number of iterations of the loop process of the second node is one, the update unit 404 does not divide the loop process of the second node (execution in one task).

An example of setting the task granularity for the second node and an example of assigning the dependency information to the second node will be described below with reference to FIG. 9. For example, the set task granularity is included in the dependency information.

By contrast, in a case where the node preceding the second node has the loop process, the update unit 404 determines a task granularity for dividing the loop process of the second node into a plurality of tasks such that a data access range is aligned with the preceding node. The data access range indicates to which range of which data each task obtained by dividing the loop process accesses. For example, in a case where the node preceding the second node has the loop process and all the loop process has a dependency relationship with the preceding node, the update unit 404 determines a loop length such that the data access range is aligned with the preceding node.

For the second node, the update unit 404 sets the determined task granularity, and assigns dependency information based on the data access pattern to update the directed graph G. Therefore, the update unit 404 divides the loop process of the second node and enables the plurality of tasks to execute the loop process in parallel. At this time, since performance may be decreased when the granularity setting is performed in loop process unit, the update unit 404 sets the task granularity such that the data access range is aligned with the preceding node.

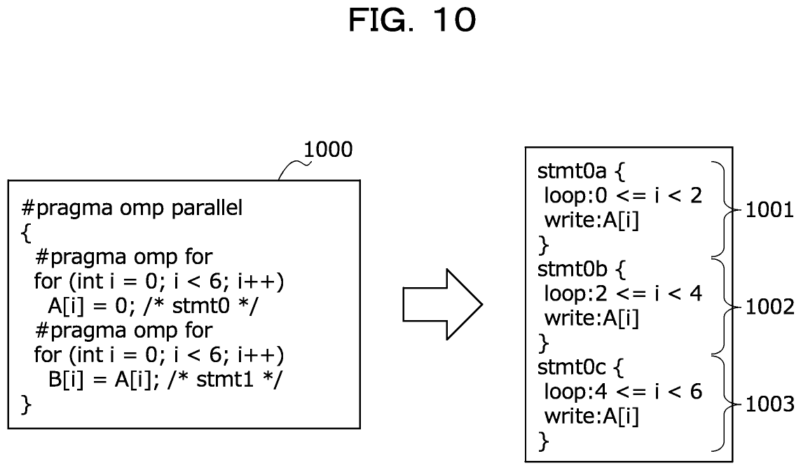

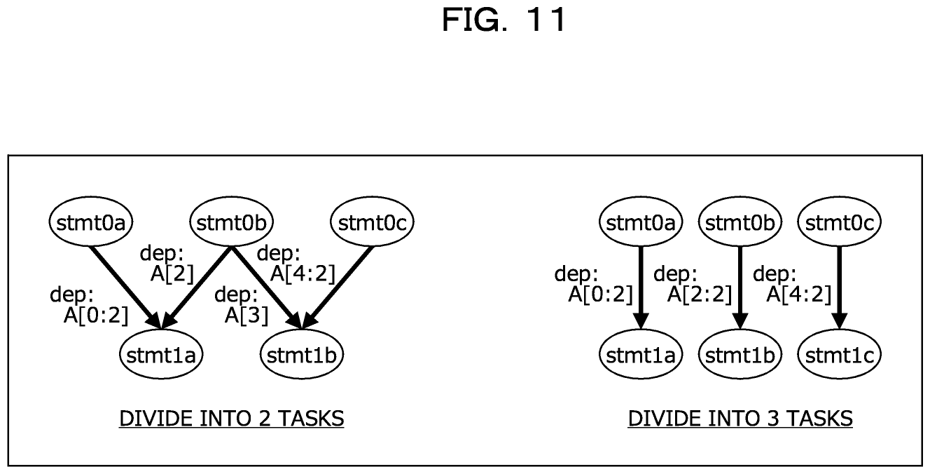

An example of determining the task granularity with which the data access range is aligned with the preceding node will be described below with reference to FIGS. 10 and 11.

For example, in a case where the directed graph G is updated, the detection unit 403 detects, from the directed graph G after update, the node Ni of which a part of the loop process has a dependency relationship with the another preceding or following node Nj. For example, the setting process of the task granularity is performed on all the nodes having the loop process in the directed graph G (the directed graph G after update). For example, the process of assigning the dependency information is performed on each node in the directed graph G (the directed graph G after update).

Based on the directed graph G after update, the conversion unit 405 converts the program P. For example, the update unit 404 converts the program P in the data parallel description into the program P in the dependent task parallel description, based on the directed graph G after update.

In details, for example, the conversion unit 405 uses an existing function of the compiler to generate the program P of the dependent task parallel description in which a computation is tasked, from the directed graph G after update. With the program P of the dependent task parallel description, read/write of data used in the task is explicitly described, based on the dependency information assigned to each node in the directed graph G after update.

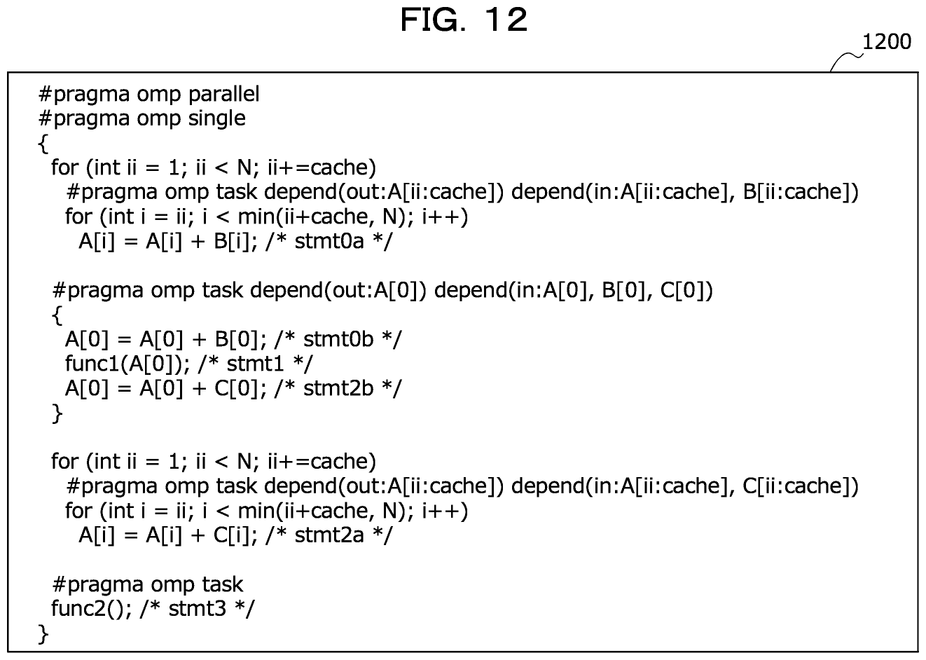

A specific example of the program P after conversion will be described below with reference to FIG. 12.

The output unit 406 outputs the program P after conversion. An output method by the output unit 406 includes, for example, storing in a storage device such as the memory 202 or the disk 204, transmitting to another computer via the communication I/F 205, and the like. Therefore, the output unit 406 passes the program P after conversion to the runtime of the compiler, or transmits the program P after conversion to the another computer (for example, an execution apparatus), for example.

The functional units (the reception unit 401 to the output unit 406) of the information processing apparatus 200 described above are realized by, for example, a compiler of the information processing apparatus 200.

(Specific Example of Directed Graph G)

A specific example of the directed graph G will be described with reference to FIGS. 5A and 5B.

FIG. 5A is an explanatory diagram illustrating the specific example of the directed graph G. FIG. 5B is an explanatory diagram illustrating a specific example of data access information. A directed graph 500 in FIG. 5A is an example of the directed graph G generated based on the dependency relationship between the statements in the program 300 illustrated in FIG. 3. The dependency relationship is a relationship based on data dependency (flow dependency, inverse flow dependency, and output dependency).

The directed graph 500 includes nodes N0 to N3 and edges e1 to e3. The node N0 represents stmt0 (statement) in the program 300. The node N1 represents stmt1 in the program 300. The node N2 represents stmt2 in the program 300. The node N3 represents stmt3 in the program 300.

The edge e1 represents a dependency relationship between stmt0 and stmt1. For example, the edge e1 indicates that there is a dependency (inverse flow dependency) of a variable A[0] between stmt0 and stmt1. The edge e2 represents a dependency relationship between stmt0 and stmt2. For example, the edge e2 indicates that there is a dependency (output dependency) of the variable A[0: N] between stmt0 and stmt2. N in [0: N] indicates the number of elements. [0: N] indicates a range of 0, 1, . . . , and N−1. The edge e3 represents a dependency relationship between stmt1 and stmt2. For example, the edge e3 indicates that there is a dependency (flow dependency) of the variable A[0] between stmt1 and stmt2. A separate node is not coupled to the node N3.

Each of the nodes N0 to N3 has, for example, data access information 501 to 504 of each of stmt0 to stmt3, as illustrated in the diagram 5B. The data access information 501 to 504 indicates an access range of a loop process of each of stmt0 to stmt3, a variable of an access (read/write) destination, and the like.

The data access information 501 is information included in the node N0, and indicates an access range “loop: 0<=i<N” of a loop process of stmt0, variables “A[i], B[i]” of a reading destination, and a variable “A[i]” of a writing destination. The data access information 502 is information included in the node N1, and indicates a variable “A[0]” of a reading destination of stmt1.

The data access information 503 is information included in the node N2, and indicates an access range “loop: 0<=i<N” of a loop process of stmt2, variables “A[i], C[i]” of a reading destination, and a variable “A[i]” of a writing destination. The data access information 504 is information included in the node N3, and indicates that there is no loop process in stmt3 and there is no variable of an access destination.

(Update Example of Directed Graph G)

An example of updating the directed graph G will be described with reference to FIGS. 6 to 9. First, an example of detecting the node Ni from the directed graph G will be described with reference to FIG. 6. The node Ni is a node of which a part of the loop process has a dependency relationship with the another preceding or following node Nj.

FIGS. 6 to 9 are explanatory diagrams illustrating an example of updating the directed graph G. For example, the detection unit 403 sequentially searches for following nodes from a root node (node N0) of the directed graph 500 to detect, from the directed graph 500, the node Ni of which a part of the loop process has a dependency relationship with the another preceding or following node Nj.

In the example of the directed graph 500 illustrated in FIG. 6, the detection unit 403, for example, performs the searching in order of “node N0→node N1→node N2→node N3” to detect the node Ni from the directed graph 500. There is a dependency on [0] of the variable A between stmt0 (node N0) and stmt1 (node N1).

For example, in stmt0, from 0 to N−1 of i, there are read and write for the variable A, and there is read for a variable B. stmt1 has read for [0] of the variable A. Therefore, there is a dependency between stmt0 and stmt1 for [0] of the variable A. In this case, the detection unit 403 detects the node N0 from the directed graph 500. The node N0 has a part of the loop process (A[0]) having a dependency relationship with the other following node N1 in the loop process included in the node N0.

Hereinafter, as a combination of the node Ni and the another node Nj, the node N0 (data access information 501) and the node N1 (data access information 502) will be described as an example.

As illustrated in FIG. 7, the update unit 404 divides the detected node N0 into a node N0a (second node) and a node N0b (first node). The node N0a is a node having a loop process other than a part of the loop process (A[0]) having a dependency relationship with the other node N0 in the loop process of the node N1.

The node N0b is a node having the part of the loop process (A[0]) having the dependency relationship with the other node N0 in the loop process of the node N1. The node N0b is coupled to the other node N1 by the edge e1. Each of the nodes N0a, N0b, and N1 has data access information 701, 702, and 502.

For example, the data access information 701 is information included in the node N0a, and indicates an access range “loop: 1<=i<N” of a loop process of stmt0a, variables “A[i], B[i]” of a reading destination, and a variable “A[i]” of a writing destination. stmt0a is a statement represented by the node N0a.

The data access information 702 is information included in the node N0b, and indicates variables “A[0], B[0]” of a reading destination and the variable “A[0]” of a writing destination of stmt0b. stmt0b is a statement represented by the node N0b.

As illustrated in FIG. 8, the update unit 404 fuses the node N0b and the other node N1 as one task to generate a node after fusing (N0b+N1). Therefore, the update unit 404 integrates processes having a dependency relationship into one, which cause synchronization when the processes are handled as separate tasks. The node after fusing (N0b+N1) has data access information 801. The data access information 801 is information included in the node (N0b+N1), and indicates the variables “A[0], B[0]” of a reading destination and the variable “A[0]” of a writing destination of stmt0b+stmt1. “stmt0b+stmt1” is a statement represented by the node (N0b+N1).

The update unit 404 updates the directed graph 500 by assigning dependency information 902 as illustrated in FIG. 9 to the node after fusing (N0b+N1). The dependency information 902 is information based on a data access pattern of the node after fusing (N0b+N1). The data access pattern of the node after fusing (N0b+N1) is specified from the data access information 801.

For example, the dependency information 902 includes depend (out: A[0]) and depend (in: A[0], B[0]). depend (out: A[0]) indicates that there is writing for A[0]. depend (in: A[0], B[0]) indicates that there is reading for A[0] and B[0]. In the example of the dependency information 902 illustrated in FIG. 9, the process of each of stmt0b and stmt1 to be executed as one task is described.

The node N0a divided from the node N0 has no preceding node, and the following node does not have a loop process. In this case, the update unit 404 determines a task granularity when the loop process of the node N0a is divided into a plurality of tasks, based on hardware information. For example, the update unit 404 determines the task granularity such that a loop length is fitted in a size of a cache line.

It is assumed that the task granularity when the loop process of the node N0a is divided into the plurality of tasks is determined to be “cache”. In this case, the update unit 404 sets the determined task granularity “cache” to the node N0a, and assigns the dependency information 901 as illustrated in FIG. 9 to update the directed graph 500.

The dependency information 901 is information based on a data access pattern in the node N0a. The data access pattern of the node N0a is specified from the data access information 701. For example, the dependency information 901 includes depend (out: A[ii: cache]) and depend (in: A[ii: cache], B[ii: cache]). ii is an integer of 1 to N−1.

cache is a task granularity determined in accordance with the size of the cache line. Based on this task granularity, the loop process included in the node N0a is divided into the plurality of tasks. For example, in the example of the dependency information 901, a first task is executed for a size of one cache line from 1 of ii, and a second task is executed for the size of one cache line from a position shifted by the size of one cache line from 1 of ii.

depend (out: A[ii: cache]) indicates that there is writing to A[ii: cache]. depend (in: A[ii: cache], B[ii: cache]) indicates that there is reading for A[ii: cache], B[ii: cache]. In the example of the dependency information 901 illustrated in FIG. 9, the set task granularity “cache” or the loop process of stmt0a executed for each task is described.

Therefore, it is possible to obtain the directed graph 500 in which the information (for example, the dependency information 901 and 902) desirable for conversion into a dependent task parallel description is assigned to each node (for example, the node N0a and the node after fusing (N0b+N1)).

(Example of Determining Task Granularity with Data Access Range Aligned with Preceding Node)

An example of determining a task granularity with which a data access range is aligned with a preceding node will be described with reference to FIGS. 10 and 11.

FIG. 10 is an explanatory diagram illustrating a division example of the preceding node. FIG. 11 is an explanatory diagram illustrating an example of determining a task granularity of a following node. A program 1000 illustrated in FIG. 10 is an example of the program P to be converted. In this case, the directed graph G in which a node representing stmt0 (referred to as the “node N1”) and a node representing stmt1 (referred to as the “node N2”) are coupled by an edge is generated.

A dependency relationship of a variable A[0: 6] exists between the node representing stmt0 and the node representing stmt1. For example, the node N1 preceding the node N2 has a loop process, and all the loop process has a dependency relationship between the node N1 and the node N2. It is assumed that a division granularity at which the loop process of stmt0 represented by the node N1 is divided into three tasks is determined based on hardware information.

Data access information 1001 is information included in the node N1, and indicates an access range “loop: 0<=i<2” of a loop process of stmt0a and a variable “A[i]” of a writing destination. stmt0a indicates a first task in a case where stmt0 is divided into three.

Data access information 1002 is information included in the node N1, and indicates an access range “loop: 2<=i<4” of a loop process of stmt0b and the variable “A[i]” of a writing destination. stmt0b indicates a second task in the case where stmt0 is divided into three.

Data access information 1003 is information included in the node N1, and indicates an access range “loop: 4<=i<6” of a loop process of stmt0c and the variable “A[i]” of a writing destination. stmt0c indicates a third task in the case where stmt0 is divided into three.

As illustrated on a left side in FIG. 11, it is assumed that a loop process of stmt1 represented by the node N2 is divided into two tasks. stmt1a indicates a first task in a case where stmt1 is divided into two. stmt1b indicates a second task in the case where stmt1 is divided into two. In this case, a dependency relationship exists between stmt0a and stmt0b, for stmt1a. For stmt1b, a dependency relationship exists between stmt0b and stmt0c.

As illustrated on a right side in FIG. 11, it is assumed that the loop process of stmt1 represented by the node N2 is divided into three tasks. stmt1a indicates a first task in a case where stmt1 is divided into three. stmt1b indicates a second task in the case where stmt1 is divided into three. stmt1c indicates a third task in the case where stmt1 is divided into three.

In this case, stmt1a has a dependency relationship with only stmt0a. stmt1b has a dependency relationship with only stmt0b. stmt1c has a dependency relationship with only stmt0c. As described above, in the case where stmt1 is divided into three tasks, the dependency relationships are reduced, as compared with the case where stmt1 is divided into two tasks.

For example, in the case where stmt1 is divided into two tasks, the dependency relationships are increased, as compared with a case where stmt1 is divided into three tasks, and thus there is a possibility that performance is decreased. Accordingly, the update unit 404 determines a task granularity when dividing the loop process of the node N2 into a plurality of tasks to the same task granularity as the preceding node N1.

Therefore, the update unit 404 may increase a speed by aligning the data access ranges between the loop processes having the dependency relationships.

A specific example of the program P after conversion will be described with reference to FIG. 12.

FIG. 12 is an explanatory diagram illustrating a specific example of the program P after conversion. A program 1200 in FIG. 12 is an example of the program P of a dependent task parallel description, and is the program 300 after conversion, that is converted based on the directed graph 500 after update. In the program 1200, a computation of each statement is tasked, and read/write of data to be used in the task, for example, depend (out: A[ii: cache]), depend (in: A[0], B[0], C [0]), and the like are explicitly described.

(Conversion Process Procedure of Information Processing Apparatus 200)

A conversion process procedure of the information processing apparatus 200 according to Embodiment 2 will be described.

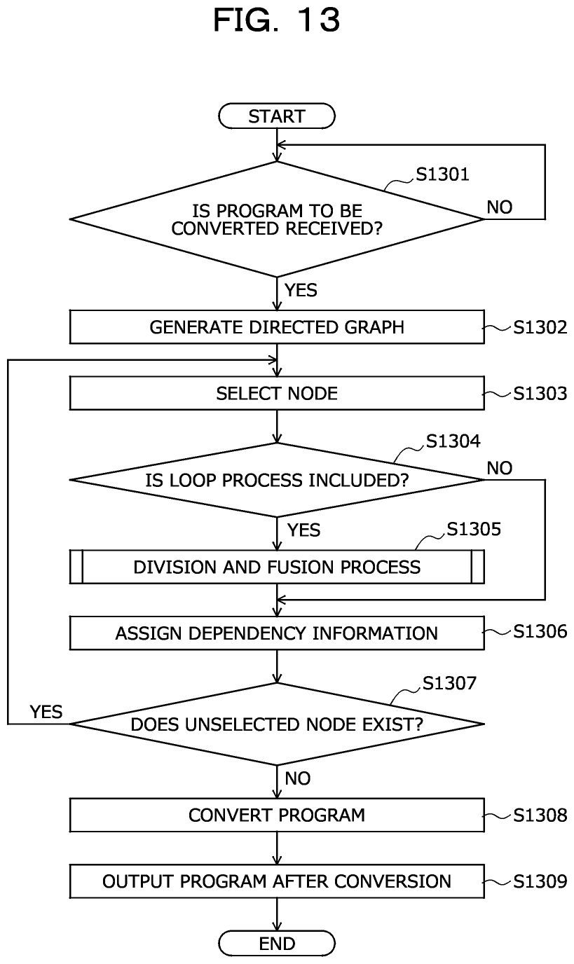

FIG. 13 is a flowchart illustrating an example of the conversion process procedure of the information processing apparatus 200 according to Embodiment 2. According to the flowchart illustrated in FIG. 13, first, the information processing apparatus 200 determines whether or not the program P to be converted is received (step S1301). The information processing apparatus 200 waits for reception of the program P to be converted (No in step S1301).

In a case where the program P to be converted is received (Yes in step S1301), the information processing apparatus 200 generates the directed graph G, based on a dependency relationship between statements in the program P (step S1302). The directed graph G is information in which the statement in the program P is a node and the dependency relationship between the statements is an edge.

After that, the information processing apparatus 200 selects the unselected node Ni, that is not selected from the directed graph G (step S1303). The directed graph G as a selection source is the directed graph G generated in step S1302 or the directed graph G after update in which dependency information is assigned to each node in step S1306.

At this time, for example, the information processing apparatus 200 first selects a root node of the directed graph G, and then sequentially selects a following node. For example, in a case where there are a plurality of following nodes, the information processing apparatus 200 selects the closest node in the program among the plurality of following nodes. In a case where there is no following node, the information processing apparatus 200 selects, for example, the uppermost unselected node.

After that, the information processing apparatus 200 determines whether or not the selected node Ni has a loop process (step S1304). In a case where the node Ni does not have the loop process (No in step S1304), the information processing apparatus 200 proceeds to step S1306. By contrast, in a case where the node Ni has the loop process (Yes in step S1304), the information processing apparatus 200 executes a division and fusion process (step S1305).

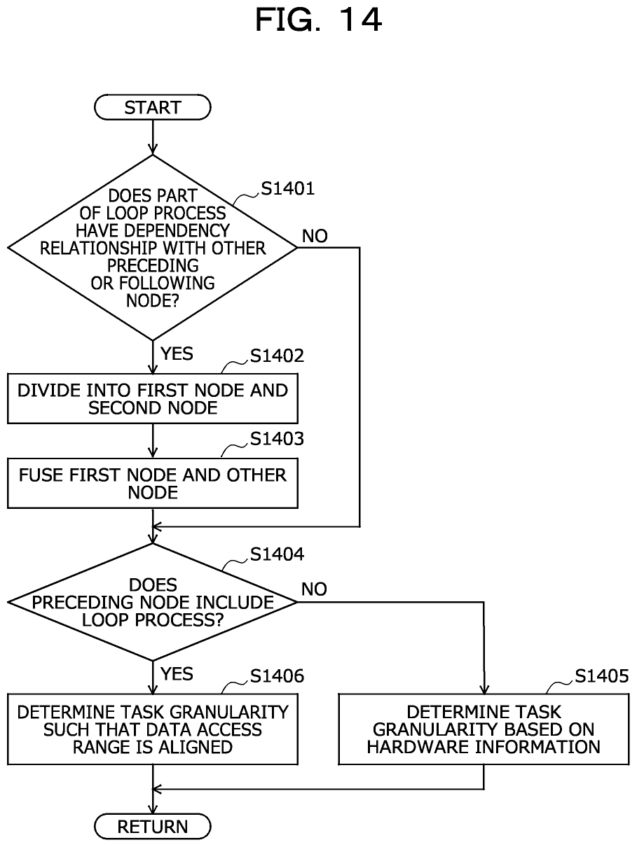

The division and fusion process is a process of dividing the node Ni and fusing the divided node Ni with the another node Nj. A specific processing procedure of the division and fusion process will be described below with reference to FIG. 14.

By assigning dependency information based on a data access pattern to each node, the information processing apparatus 200 updates the directed graph G (step S1306). A node to which the dependency information is to be assigned is, for example, the node Ni selected in step S1303 or a node after fusing fused in step S1403 illustrated in FIG. 14, which will be described below. For example, a task granularity determined in step S1405 or step S1406 illustrated in FIG. 14, which will be described below, is set in the dependency information.

After that, the information processing apparatus 200 determines whether or not there is an unselected node that is not selected from the directed graph G (step S1307). In a case where there is the unselected node (Yes in step S1307), the information processing apparatus 200 returns to step S1303.

By contrast, in a case where there is no unselected node (No in step S1307), the information processing apparatus 200 converts the program P based on the directed graph G after update (step S1308). After that, the information processing apparatus 200 outputs the program P after conversion (step S1309), and ends a series of processes according to the present flowchart.

Therefore, the information processing apparatus 200 may convert the program P of a data parallel description into the program P of a dependent task parallel description.

A specific processing procedure of the division and fusion process in the step S1305 will be described with reference to FIG. 14.

FIG. 14 is a flowchart illustrating an example of the specific processing procedure of the division and fusion process. According to the flowchart illustrated in FIG. 14, first, based on the dependency relationship represented by the edge coupled to the selected node Ni, the information processing apparatus 200 determines whether or not a part of the loop process of the node Ni has a dependency relationship with the another preceding or following node Nj (step S1401).

In a case where the part of the loop process does not have the dependency relationship with the another preceding or following node Nj (No in step S1401), the information processing apparatus 200 proceeds to step S1404. By contrast, in a case where the part of the loop process has the dependency relationship with the another preceding or following node Nj (Yes in step S1401), the information processing apparatus 200 divides the selected node Ni into a first node and a second node (step S1402).

The first node is a node having only a part of the loop process having a dependency relationship with the another node Nj, in the loop process of the node Ni. The second node is a node having only the loop process other than the part of the loop process having the dependency relationship with the another node Nj, in the loop process of the node Ni.

The information processing apparatus 200 fuses the divided first node and the another node Nj (step S1403). After that, the information processing apparatus 200 determines whether or not the selected node Ni or a node preceding the divided second node has a loop process (step S1404).

In a case where the preceding node does not have the loop process (No in step S1404), the information processing apparatus 200 determines a task granularity when the loop process included in the node Ni or the second node is divided into a plurality of tasks based on the hardware information (step S1405), and returns to the step in which the division and fusion process is called.

By contrast, in a case where the preceding node has the loop process (Yes in step S1404), the information processing apparatus 200 determines the task granularity when the loop process of the node Ni or the second node is divided into the plurality of tasks (step S1406) such that a data access range is aligned with the preceding node, and returns to the step in which the division and fusion process is called.

Therefore, in a case where only a part of the loop process of the node Ni has a dependency relationship with the another preceding or following node Nj, the information processing apparatus 200 may reduce the number of generated tasks by dividing only the location into separate nodes and fusing the separate node with the another node Nj. The information processing apparatus 200 may determine an appropriate task granularity when the loop process is divided into a plurality of tasks, based on hardware information or a data access range of the preceding node.

As described above, with the information processing apparatus 200 according to Embodiment 2, it is possible to generate the directed graph G in which the statement in the program P is a node and a dependency relationship between the statements is an edge, based on the dependency relationship between the statements in the program P of a data parallel description. With the information processing apparatus 200, it is possible to detect, from the directed graph G, the node Ni of which a part of the loop process having a dependency relationship with the another preceding or following node Nj, based on a dependency relationship represented by the edge in the generated directed graph G. With the information processing apparatus 200, it is possible to update the directed graph G by dividing the detected node Ni into a first node having a part of the loop process and a second node having the loop process other than the part of the loop process, fusing the divided first node and the another node, and assigning dependency information based on a data access pattern to the node after fusing. With the information processing apparatus 200, it is possible to convert the program P by a data parallel description into the program P by a dependent task parallel description, based on the directed graph G after update.

Therefore, in a case where only the part of the loop process of the node Ni has the dependency relationship with the another preceding or following node Nj, the information processing apparatus 200 may divide the part into separate nodes and fuse the separate node and the another node Nj. Therefore, in task parallelization, it is possible to reduce the number of generated tasks while acquiring parallelism, and to improve parallelization efficiency.

With the information processing apparatus 200, in a case where a node preceding the second node does not have a loop process, it is possible to determine a task granularity when a loop process of the second node is divided into a plurality of tasks, based on the hardware information. With the information processing apparatus 200, it is possible to update the directed graph G by setting the determined task granularity and assigning dependency information based on a data access pattern to the second node.

Therefore, the information processing apparatus 200 may improve the parallelization efficiency by dividing the loop process (a plurality of processes) into tasks having an appropriate granularity, based on the hardware information. For example, the information processing apparatus 200 may determine a task granularity when the loop process of the second node is divided into a plurality of tasks, based on a size of a cache line included in the hardware information. In this case, the task granularity may be set in consideration of the size of the cache line corresponding to the amount of data that may be processed at one time, and the number of generated tasks may be reduced while improving use efficiency of a cache memory.

With the information processing apparatus 200, in a case where a node preceding the second node has a loop process, it is possible to determine the task granularity when the loop process of the second node is divided into the plurality of tasks such that the data access range is aligned with the preceding node. For example, in a case where a node preceding the second node has a loop process and all loop process has a dependency relationship with the preceding node, the information processing apparatus 200 determines a task granularity such that the data access range is aligned with the preceding node. With the information processing apparatus 200, it is possible to update the directed graph G by setting the determined task granularity and assigning dependency information based on a data access pattern to the second node.

Therefore, the information processing apparatus 200 aligns the data access range between the loop processes having the dependency relationship to reduce an increase in the dependency relationship between the tasks and achieve a high-speed.

With the information processing apparatus 200, it is possible to generate the directed graph G, based on the dependency relationship based on any data dependency of the flow dependency, the inverse flow dependency, and the output dependency between the statements in the program P.

Therefore, the information processing apparatus 200 may generate the directed graph G, based on the data dependency.

With the information processing apparatus 200, it is possible to output the program P after conversion (program P in the dependent task parallel description).

Therefore, the information processing apparatus 200 may pass the program P after conversion to a runtime of a compiler or transmit the program P after conversion to another computer (for example, an execution apparatus).

From these, with the information processing apparatus 200 according to Embodiment 2, it is possible to reduce an overhead by reducing the number of generated tasks while acquiring parallelism by setting the task having an appropriate granularity, and it is possible to improve performance of the HPC program.

The conversion method described in the present embodiment may be realized by executing a program prepared in advance by a computer such as a personal computer or a workstation. The conversion program is recorded in a computer-readable recording medium such as a hard disk, a flexible disc, a CD-ROM, a DVD, or a USB memory, and is executed by being read by the computer from the recording medium. The conversion program may be distributed via a network such as the Internet.

The conversion apparatus 101 (information processing apparatus 200) described in the present embodiment may also be realized by an integrated circuit (IC) for specific application, such as a standard cell or a structured application-specific integrated circuit (ASIC), or by a programmable logic device (PLD), such as a field-programmable gate array (FPGA).

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a conversion program causing a computer to execute a process comprising:
generating, based on a dependency relationship between statements in a program, a directed graph in which the statement in the program is a node and the dependency relationship is an edge;
detecting, based on the dependency relationship represented by the edge in the generated directed graph, a node of which a part of a loop process has a dependency relationship with another preceding or following node, from the directed graph;
updating the directed graph by dividing the detected node into a first node that has the part of the loop process and a second node that has a loop process other than the part of the loop process, fusing the divided first node and the another node, and assigning dependency information based on a data access pattern to a node after fusing; and
converting the program, based on the directed graph after update.

2. The non-transitory computer-readable recording medium according to claim 1,
wherein in the updating, in a case where a node preceding the second node does not have a loop process, a task granularity at a time of dividing the loop process included in the second node into a plurality of tasks is determined based on hardware information, and the determined task granularity is set to the second node and dependency information based on a data access pattern is assigned to the second node to update the directed graph.

3. The non-transitory computer-readable recording medium according to claim 1,
wherein in the updating, in a case where a node preceding the second node has a loop process, a task granularity at a time of dividing the loop process included in the second node into a plurality of tasks is determined such that a data access range is aligned with the preceding node, and the determined task granularity is set to the second node and dependency information based on a data access pattern is assigned to the second node to update the directed graph.

4. The non-transitory computer-readable recording medium according to claim 1,
wherein the program is a program of a data parallel description, and
in the converting,
the program of the data parallel description is converted into a program of a dependent task parallel description, based on the directed graph after update.

5. The non-transitory computer-readable recording medium according to claim 1,
wherein the dependency relationship is a relationship based on any data dependency of a flow dependency, an inverse flow dependency, and an output dependency.

6. The non-transitory computer-readable recording medium according to claim 1,
wherein the conversion program causes the computer to execute a process of
outputting the program after conversion.

7. The non-transitory computer-readable recording medium according to claim 2,
wherein the hardware information includes a size of a cache line.

8. A conversion method comprising:
generating, based on a dependency relationship between statements in a program, a directed graph in which the statement in the program is a node and the dependency relationship is an edge;
detecting, based on the dependency relationship represented by the edge in the generated directed graph, a node of which a part of a loop process has a dependency relationship with another preceding or following node, from the directed graph;
updating the directed graph by dividing the detected node into a first node that has the part of the loop process and a second node that has a loop process other than the part of the loop process, fusing the divided first node and the another node, and assigning dependency information based on a data access pattern to a node after fusing; and
converting the program, based on the directed graph after update.
